(19) United States
(12) Patent Application Publication
(10) Pub. No.: US 2002/0168245 A1
(43) Pub. Date: Nov. 14, 2002

(54) Threaded screw having cutting notch structures

(76) Inventor: Hsu Kuo-Tai, Taipei (TW)

Correspondence Address: HSU Kuo-Tai, PO Box 82-144, Taipei, TW

(21) Appl. No.: 09/851,562

(22) Filed: May 10, 2001

(51) Int. Cl. F16B 25/10

(52) U.S. Cl. 411/387.1

(57) ABSTRACT

A threaded screw with cutting notch structures thereon comprising a screw body and a plurality of screw threads provided along the screw body, characterized in that at least two notches, corresponding to each other are provided at the front end of the screw body, the interior space of the notch is tapered upward from the bottom forming into a slanting cut face and a cut wall, and the slanting cut face is corresponding to the cut wall and forming an inclination angle of 91 to 119 degree, thereby when the end portion of the first screw thread is screwed into a locking element, the screw threads are easily screwed in the locking element with the cut wall cuts the locking element and the debris of the locking element can be expelled by the space of the cutting notch and a lower resistance allowing a faster screwing process into the locking element.

### BACKGROUND OF THE INVENTION

(a) Field of the Invention

The present invention relates a screw structures, and in particular, to a screw having cutting notches formed along the shank of the screw facilitating the mounting thereof into a locking element such as wood materials, etc.

(b) Description of the Prior Art

A conventional screw has a plurality of threads having a sharp point at one end and a head at the other end. A screw driver is used to force the screw into a locking element such as wood materials or the like. However, this conventional screw structure may not be easily forced into the locking element without damaging the texture of the locking material.

Referring to FIG. 1, there is shown a conventional screw structure having a cutting notch at the end point (tip) of the screw thereof comprising a shank 1 and a plurality of threads 10 positioned along the body of the shank.

At the bottom end of the shank 1, a horizontal cutting notch 11 is provided (referring to FIG. 2 for the sectional view of the screw). When the screw is mounted into the locking element 2, the cutting notch 11 is used to expel the debris which are planed away from the locking element 2 so as to reduce the resistance force against the screw-mounting. However, the inclination angle of the cutting notch 11 is 90 degree, a right-angled cutting wall 110 is obtained. Due to the position of the cutting wall being perpendicular to the locking element 2, this will cause a great resistance to the screw. As a result, a greater force is required for the screw to be mounted into the locking element.

In addition, when the screw 1 enters deeper into the locking element 2, the formation of debris increases and as a result of a single notch and the 90 degree inclination angle, a limited space is formed and the debris will be discharged to the groove between the threads 10. As a result, his will block the front end of the screw 1 and another resistance will be formed again. A greater force is further needed to urge the screw 1 to be smoothly mounted. If the locking element 2 is a high density wood material or hand wood, the notch 11 cannot hold the debris from the locking material 2 and a crack will be formed to the wood material (as shown in FIG. 3). In view of the above, it is an object of the present invention to provide a threaded screw having cutting notch structures which provides a low resistance during the mounting of the screw into a locking material (wood material).

### SUMMARY OF THE INVENTION

Accordingly, it is an object of the present invention to provide a threaded screw having cutting notch structures which mitigates the drawback of the structure of the conventional screw having a single notch with an angle of 90 degree.

Yet another object of the present invention is to provide a threaded screw having cutting notch structures, wherein the resistance against the inward screwing of the screw is greatly reduced and a rapid mounting process is provided.

An aspect of the present invention is to provide a threaded screw with cutting notch structures thereon comprising a screw body and a plurality of screw threads provided along the screw body, characterized in that at least two notches, corresponding to each other are provided at the front end of the screw body, the interior space of the notch is tapered upward from the bottom forming into a slanting cut face and a cut wall, and the slanting cut face is corresponding to the cut wall and forming an inclination angle of 91 to 119 degree, thereby when the end portion of the first screw thread is screwed into a locking element, the screw threads are easily screwed in the locking element with the cut wall cuts the locking element and the debris of the locking element can be expelled by the space of the cutting notch and a lower resistance allowing a faster screwing process into the locking element.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing the mounting of a conventional screw to a locking element.

FIG. 2 is a sectional view of the conventional screw along line A-A of FIG. 1.

FIG. 3 is a sectional view of the conventional screw along line B-B of FIG.

FIG. 4 is a perspective view of the screw of the present invention.

FIG. 5 is an elevational view of the screw of the present invention.

FIG. 6 is a sectional view of the screw along line C-C of FIG. 4.

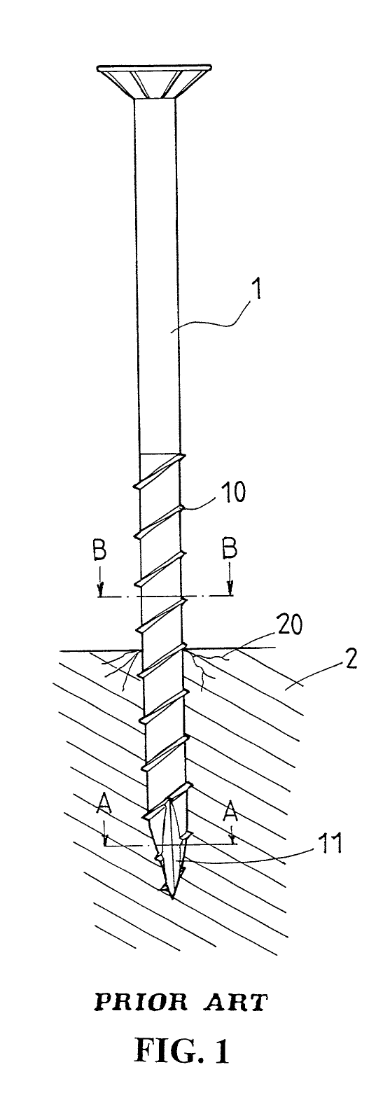

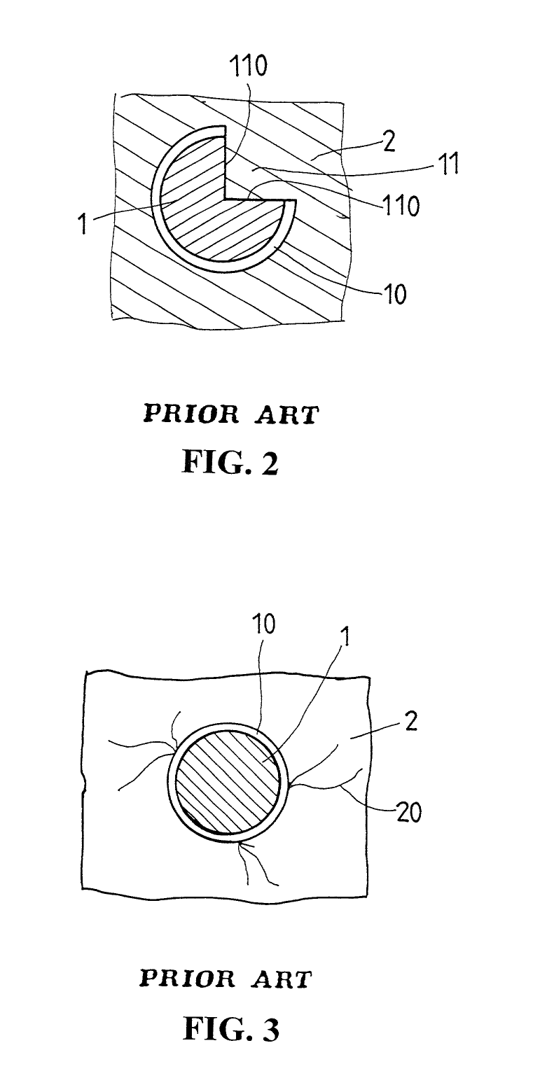

### DETAILED DESCRIPTION OF THE PRESENT INVENTION

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

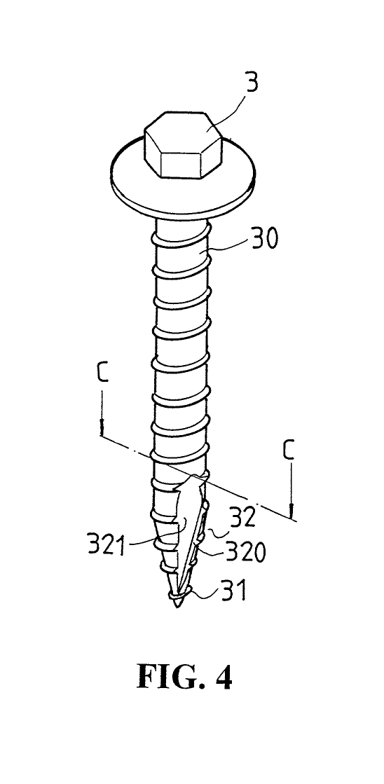

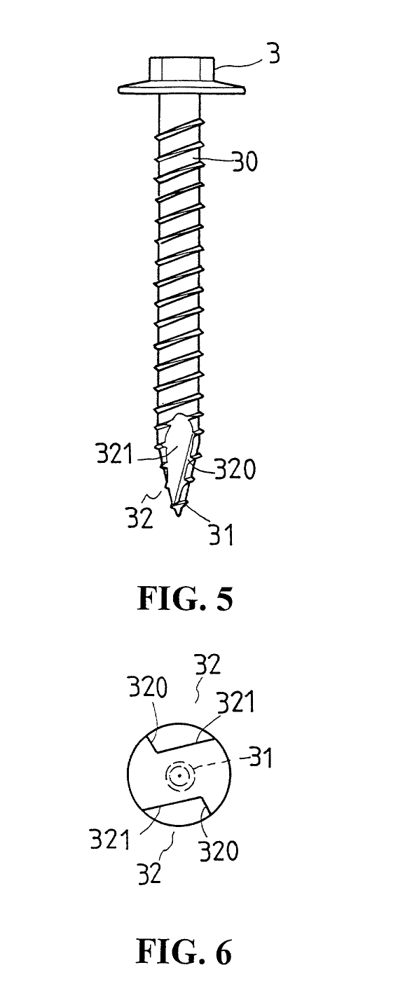

Referring to FIG. 4, there is shown a threaded screw with cutting notch structures having a screw body 30, and a plurality of threads 31 along the surface of the screw body 30, wherein at least a pair of cutting notches 32, corresponding to each other are provided closer to the bottom end of the screw body 30 and a first screw thread 31 is retained. In accordance with the present invention, the notches 32 are slanted and positioned in vertical. The notches 32 are not limited to two and in the present invention, two notches 32 are used to facilitate description of the present invention. The interior space of the cutting notch 32 is tapered upward where the wide at the top is larger than that at the bottom, and forms a slanted cutting face 320 and as slanted cutting wall 321. The inclination angle formed by the slanted cutting face 320 with respect to the cutting wall 321 ranges from 91 degree to 119 degree (referring to FIGS. 5 and 6).

In accordance with the present invention, when the end portion of the screw thread 31 is screwed into a locking element, the first thread 31 is first screwed into it and is positioned at the locking element. Then, by means of the slanted cutting wall 321 of the cutting notches, the screw can be screwed in vertically and at the same time planes away some material of the locking element, and the entire screw 3 is thus secured into the locking element. The space of the cutting notch 32 expels the debris of the locking element along the grooves between the threads 31. Thus, the screw 3 is positioned with a low resistance force and the debris will not block the path between the screw 30 and the locking element. In addition, the locking element will not be broken as a result of the mounting of the screw.

In accordance with the present invention, the threaded screw with cutting notch structures provide the following advantages:

1) The resistance from the locking element in the course of mounting the screw is greatly reduced.

2) The crack formed at the point of screw-mounting is reduced to a

3) The efficiency of a screw-mounting is greatly increased.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A threaded screw with cutting notch structures thereon comprising a screw body and a plurality of screw threads provided along the screw body, characterized in that at least two notches, corresponding to each other are provided at the front end of the screw body, the interior space of the notch is tapered upward from the bottom forming into a slanting cut face and a cut wall, and the slanting cut face is corresponding to the cut wall and forming an inclination angle of 91 to 119 degree, thereby when the end portion of the first screw thread is screwed into a locking element, the screw threads are easily screwed in the locking element with the cut wall cuts the locking element and the debris of the locking element can be expelled by the space of the cutting notch and a lower resistance allowing a faster screwing process into the locking element.
